(19) United States
(12) Patent Application Publication
(10) Pub. No.: US 2016/0293289 A1
(43) Pub. Date: Oct. 6, 2016

(54) METHOD FOR STRUCTURING A TRANSPARENT CONDUCTIVE MATRIX COMPRISING NANO MATERIALS

(71) Applicant: Merck Patent GmbH, Darmstadt (DE)

(72) Inventors: Werner STOCKUM, Reinheim (DE); Christian MATUSCHEK, Frankfurt am Main (DE)

(73) Assignee: Merck Patent GmbH, Darmstadt (DE)

(21) Appl. No.: 15/035,013

(22) PCT Filed: Oct. 16, 2014
(86) PCT No.: PCT/EP2014/002796

§ 371 Date: May 6, 2016

(30) Foreign Application Priority Data
Nov. 8, 2013 (EP) 13005275.6

(51) Int. Cl. H01B 1/22; C09K 13/06; C23F 1/30; C09K 13/08

(52) U.S. Cl. CPC H01B 1/22; C09K 13/08; C09K 13/06; C23F 1/30

(57) ABSTRACT

The present invention refers to a method for selectively structuring of a polymer matrix comprising AgNWs (silver nano wires) or silver nano particles (Ag nano ink) or comprising mixtures of AgNWs and silver nano particles on a flexible plastic substructure or solid glass sheet. The method also includes a suitable etching composition, which allows to process the method in an industrial scale.

### FIELD OF THE INVENTION

The invention relates to a method for structuring of a transparent conductive matrix comprising nano materials on a flexible and transparent plastic film or on glass sheet. The invention also comprises a printing method and a new etching composition for carrying out the method on an industrial scale.

### BACKGROUND OF THE INVENTION

### State of the Art

A transparent conductive film is a light-transmissive conductive material used for FPDs (flat panel displays) such as liquid crystal displays (LCDs) and electroluminescence displays (ELDs), solar cells, and touch panels. These transparent conductive films are composed of indium tin oxide, indium oxide, tin oxide, and zinc oxide, and in particular, of indium tin oxide (hereinafter, referred to as ITO).

Transparent conductive film materials are usually made of doped metal oxides, most commonly indium tin oxide (ITO). However ITO has a number of drawbacks and in future it is unlikely to be the material of choice for the production of optoelectronic devices.

The problems concerning ITO films and such layers predominantly refer to the cost of indium, their technical performance and conditions in their production. The latter two issues become more significant, due to the increase of display sizes in the future and the use of flexible plastic film materials instead of glass. The new types of displays have to be very flexible and have to include transparent electrodes which can be produced at low temperature and low costs, and if desired have to be of very large size. In top these display have to have a low sheet resistance and high transparency.

It is straightforward to achieve sheet resistance of about 10 Ohm/sq for transmittance of >90% with ITO.

Alternative materials are under investigation since several years. In order to catch the ITO level, new nanostructure thin film materials are in focus of new TC (transparent conductive) materials. Graphene and carbon nano tube films have been studied. However, the main issue is still the sheet resistance and high transparency.

Another group of new nanostructure thin film materials are silver nanowires films (AgNW) as well as nanosilver dispersions, which are fixed as a random mesh. Latest results did show very promising results in comparison with ITO standard. It was possible to achieve a sheet resistance with AgNW of about 13 Ohm/sq for transmittance of 85% and a sheet resistance with nanosilver dispersion of about 8 Ohm/sq for transmittance of 88%. Therefore, it is expected a wide implementation of the nanosilver technology for display and photovoltaic market in future due to a simplified production of these nanomaterials and due to low cost deposition methods on plastic-film or glass substrates. (Sukanta, D.; Thomas, M. H.; Philip, E. L.; Evelyn, M. D.; Peter, N. N.; Werner, J. B.; John, J. B.; Jonathan, N. C., (2009). “Silver Nanowire Networks as Flexible, Transparent, Conducting Films: Extremely High DC to Optical Conductivity Ratios”. American Chemical Society.

A promising low cost alternative product in comparison to silicon solar cells or semiconductor devices can be found in organic photovoltaic devices (OPVs), if their power conversion efficiency can be increased (Liquing, Y.; Tim, Z.; Huaxing, Z.; Samuel, C. P.; Benjamin J. W.; Wei, Y., (2011). “Solution-Processed Flexible Polymer Solar Cell with Silver Nanowire Electrodes”. Curriculum of Applied Sciences and Engineering.

According to the current state of the art, in a Silver-Nanowire-, or Carbon-Nanotube-, or a polymer based substrate any desired structure can be structured by laser methods or, by wet-chemical methods (after masking) or by dry-etching methods.

In laser supported etching methods the laser beam scans the entire etch pattern dot by dot or line by line in the case of vector-orienting systems, on the substrate, which, in addition to a high degree of precision, also requires considerable adjustment effort and is very time-consuming.

Wet-chemical and dry etching methods include material-intensive, time-consuming and expensive process steps:

Masking of the areas not to be etched, for example by photolithography: production of a negative or positive of the etch structure (depending on the resist), coating of the substrate surface (for example by spin-coating with a liquid photoresist),drying of the photo-resist, exposure of the coated substrate surface, development, rinsing, if desired drying, etching of the structures by dip methods (for example wet etching in wet-chemical banks): dipping of the substrates into the etch bath, etching process, repeated rinsing in H₂O cascade basins, drying and final photoresist removal (stripping). This can be carried out by means of solvents, such as, for example, acetone, or dilute aqueous alkaline solutions. The substrates are finely rinsed and dried. This last step involves the risk, that polymer layers comprising AgNW or Nano silver dispersion or mixtures thereof are affected by solvents or acidic solutions or that the layered material is delaminated.

Dry etching method of TC (transparent conductive) layers is also known, using a patterned masking layer and etching the thin conductive film in a plasma etch chamber using boron trichloride (BCl₃) and dichloride (Cl₂) and a substrate bias power.

### OBJECT AND SUMMARY OF THE INVENTION

Therefore, the object of the present invention is a method for selective etching of nanosized conductive materials (Ag, Cu, Al, Ni, Cr, Mo, Sn, Zn, Ti, Sb, Bi, Ga) or metaloxide (ZnO, TiO2) inside a polymer matrix, preferably a method for the selective decomposition and release of silver nanowires (AgNWs) or agglomerated silver nanoparticles (nanosilver dispersion) or mixtures thereof comprised in transparent conductive polymer layers positioned on a plastic substructure and/or on a glass sheet, and whereby the method comprises the steps of
a) printing an acidic etching paste onto the surface of a composite material,
b) etching for a predetermined period (fixed dwell time) and
c) cleaning the substrate.

An especially important aspect of the present invention is that the etching takes place without removal of the polymer matrix. Suitable etching composition s of the present invention comprise an etchant selected from the group NH₄HF₂, NH₄F, HBF₄, H₂SO₄, HNO₃, Fe(NO₃)₃, FeCl₃, H₃PO₄, Triethylmmonium chloride, Diammoniumhydrogenphosphate, KBrO₃, KClO₃, KClO₄, CuCl₂, KMnO₄, K₂CrO₄, HCl, NH₄OH, H₂O₂, KNO₃, K₃PO₄, and FeSO₄ or a mixture thereof. These etchants are mixed with a solvent selected from the group water, mono- or polyhydric alcohols, such as glycerol, 1,2-propanediol, 1,2-Ethandiol, 2-Propanol, 1,4-butanediol, 1,3-butanediol, 1,5-pentanediol, 2-ethyl-1-hexenol, ethylene glycol, diethylene glycol and dipropylene glycol, ether, such as ethylene glycol monobutyl ether, triethylene glycol monomethyl ether, diethylene glycol monobutyl ether, diethylene glycol monoethyl ether, diethylene glycol monoethyl ether and dipropylene glycol monomethyl ether, ester, such as [2,2-butoxy(ethoxy)]ethyl acetate, isopropyl acetate, isopropyl formate, esters of carbonic acid, such as propylene carbonate, ketone, such as acetone, 2-butanon, acetophenone, methyl-2-hexanone, 2-octanone, 4-hydroxy-4-methyl-2-pentanone, pyrrolidone and 1-methyl-2-pyrrolidone, caprolactam, 1,3.Dioxolan, 2-Methyl-1,3-Dioxolan, aldehyde, such as acetaldehyd, as such or mixtures thereof, in an amount in the range of 10 to 90% by weight, preferably in an amount in the range of 15 to 85% by weight based on the total amount of the medium.

The etching pastes used in step a) comprise organic and/or inorganic particles or mixtures thereof in an amount in the range of 0.5 to 20% by weight, based on the total amount of the etching medium. The comprising inorganic particles, having mean particle sizes in the range of 50 nm to 150 nm, may be incorporated in an amount in the range of 0.5 to 5% by weight, based on the total amount of the etching medium. These particles are selected from the group calcium fluoride, boron oxide, carbon black, graphite, fumed silica and sodium chloride and can act as fillers and thickeners. Organic particles or mixtures thereof may be added in an amount in the range of 5 to 20% by weight, based on the total amount of the etching medium. These particles show mean particle sizes in the range of 0.5 μm to 20 μm and are selected from the group polystyrene, acrylic polymers, polyamides, polyimides, methacrylic polymers, melamine, urethane, benzoguanine and phenolic resins, silicone resins, micronized cellulose, fluorinated polymers (PTFE, PVDF inter alia) and micronized wax and can act as filler and thickener.

These etching paste compositions can be very good applied to the surfaces to be treated by screen printing, gravure-printing, inkjetting, dispensing or micro-jetting. In the following process step (step b) the substrate is heated for 10 s-15 min, preferably for 30 s to 7 min, whereby the temperature is kept in the range of 20 to 170° C., preferably the heating of the substrate lasts for 5 minutes at 100° C. Then the substrate is rinsed with DI water or with a solvent; and that the rinsed part is dried with dry air or nitrogen flow.

In particular, the present invention consists in a method for selectively etching of silver nanowires (AgNWs) or agglomerated silver nanoparticles (nanosilver dispersion) comprised in transparent conductive polymer layers positioned on a plastic substructure consisting of polyurethane, PEN (polyethylene naphthalate) or PET (polyethylene terephatalate). Preferably the embedded silver nanowires (AgNWs) have a length variation from 1.5 to 15 μm and diameter varies from 40-150 nm and suitable silver nano particles (Ag nano ink) have diameters in the range of 1.5 to 15 μm, preferably mean diameters in the range of 40-150 nm. These particles are preferably embedded in conductive polymer layers prepared from polymers selected from the group poly(3-octylthiophene) (P3OT), poly(3-hexyl-thiophene) polymer (P3HT), poly(3,4-ethylene dioxythiophene), or other polythiophene derivatives and polyanilines, or is a combination of polymers like poly[2-methoxy-5-(3′,7′-dimethyloctyloxy)1,4-phenylene vinylene] (MDMO-PPV)/1-(3-methoxycarbonyl)-propyl-1-phenyl)[6,6]C₆₁ (PCBM); poly(3-hexyl-thiophene) polymer (P3HT)/(PCBM) and poly(3,4-ethylene dioxythiophene)/poly(styrene sulfonate) (PEDOT/PSS).

A particular object of the present invention is that by the present process narrow lines, dot or structures of less than 90 μm, preferably less than 80 μm, may be printed.

### DETAILED DESCRIPTION OF THE PRESENT INVENTION

The disadvantages of the conventional etching methods as described before are time-consuming, need several process steps, are material-intensive and include expensive process steps. On top of this, these known etching methods are in some cases complex in view of the technical performance, safety, and are only carried out batch-wise.

Therefore, the objective of the present invention is to provide a new etching composition, which is suitable to be employed in a simplified etching method for polymer-surfaces. It is also an objective of the present invention to provide an improved etching method for polymer-surfaces, which can be carried out with throughputs as high as possible, and which is significantly less expensive than conventional wet and dry etching methods in the liquid or gas phase.

Alternative structuring technologies are needed for this purpose and a lot of experiments were carried out to etch AgNWs comprising layers by exposure to printed pasty etching compositions at elevated temperatures or by exposure of thermal radiation or infrared radiation. Unexpectedly it was found by these experiments that AgNW comprising layers can be etched selectively inside the polymer matrix by use of an etchant mixture paste vehicle. Surprisingly a complete extraction of silver out of the remaining tubes inside the coated film was achieved. This astonishing result has much less colour effect than previous structuring methods (very low contrast ratio). The new squeegee etching paste can be applied with screen printing process for the treatment of AgNW comprising polymer layers for mass production of flexible photovoltaic devices and comparable products, like touch panels, displays (LCD) or solar cells.

Surprisingly, experiments have shown that difficulties due to the comprising AgNW material may be overcome by the etching method according to the present invention and rough surface topographies of AgNW materials as described above may be etched to smooth and even surfaces at the bottom of etched lines and structures, if the etching compositions are adapted to the chemical and physical nature of the layers comprising AgNWs. If desired, only AgNWs comprising polymer layers of the treated composite material may be patterned by the etching method according to the present invention. But if also the polymer matrix has to be etched by this etching step, the conditions of etching and the applied etching composition may be changed. These experiments have also shown, that similar materials comprising silver nano particles (silver nano ink) instead of AgNWs or comprising silver nano particles and AgNWs in combination are also etched with comparable good results.

In addition to this, it was found, that advantageously according to the present invention the suitable etching pastes can be applied with high resolution and precision in a single process step onto the substrate surfaces at areas to be etched. There is no need for a previous protection with a photoresist layer on areas, which have to stay unchanged.

Thus, a method with a high degree of automation and high throughput is provided, which is suitable for the transfer of the etching paste to the substrate surface to be etched using a printing technology. In particular, printing technologies can be applied like screen printing, silk-screen printing, pad printing, stamp printing, gravure printing, mikrojet-printing and ink-jet printing methods and which are known to the person skilled in the art, but also dispensing and manual application are possible.

In particular the present invention refers to a method of selectively etching a polymer matrix comprising AgNWs (silver nano wires) on glass sheets or a plastic substructure, preferably on a substructure consisting of polyethylene terephthalate (PET), polyethylene naphthalate (PEN) or polyurethane.

Thus, in step a) preferably an etching paste is printed onto the surface of the composite material, which comprises an etchant selected from the group NH₄HF₂, NH₄F, HBF₄, H₂SO₄, HNO₃, Fe(NO₃)₃, FeCl₃, H₃PO₄, Triethylmmonium-chloride, Diammoniumhydrogenphosphate, KBrO₃, KClO₃, KClO₄, CuCl₂, KMnO₄, K₂CrO₄, HCl, NH₄OH, H₂O₂, KNO₃, K₃PO₄, and FeSO₄.

The applied paste compositions may comprise a solvent, selected from the group water, mono- or polyhydric alcohols, such as glycerol, 1,2-propanediol, 1,2-Ethandiol, 2-Propanol, 1,4-butanediol, 1,3-butanediol, 1,5-pentanediol, 2-ethyl-1-hexenol, ethylene glycol, diethylene glycol and dipropylene glycol, and ethers thereof, such as ethylene glycol monobutyl ether, triethylene glycol monomethyl ether, diethylene glycol monobutyl ether, diethylene glycol monoethyl ether and dipropylene glycol monomethyl ether, and esters, such as [2,2-butoxy(ethoxy)]ethyl acetate, isopropyl acetate, isopropyl formate, esters of carbonic acid, such as propylene carbonate, ketones, such as acetone, 2-butanon, γ-butyrolactone, acetophenone, methyl-2-hexanone, 2-octanone, 4-hydroxy-4-methyl-2-pentanone, pyrrolidone, 1-methyl-2-pyrrolidone, caprolactam, 1,3.Dioxolan, 2-Methyl-1,3-Dioxolan, aldehyds, such as acetaldehyd, as such or in a mixture.

In a most preferred embodiment the etching paste comprises γ-butyrolactone as solvent. The solvent may be contained in an amount of from 10 to 90% by weight, preferably in an amount of from 15 to 85% by weight, based on the total amount of the medium.

In a particular embodiment the applied etching paste comprises organic or inorganic filler particles or mixtures thereof.

The applied etching paste preferably comprises inorganic or organic particles or mixtures thereof as filler and thickener. The polymer particles may be selected from the group of polystyrenes, polyacrylics, polyamides, polyimides, polymethacrylates, melamine, urethane, benzoguanine and phenolic resins, silicone resins, micronised cellulose and fluorinated polymers (PTFE, PVDF, inter alia) and micronised wax (micronised polyethylene wax). The inorganic particles may be selected from the group of aluminium oxides, calcium fluoride, boron oxide, carbon black, graphite, fumed silica and sodium chloride and may act as filler and thickener.

Suitable etching pastes according to the present invention comprise the particulate organic or inorganic fillers or mixtures thereof and thickeners homogeneously distributed in amounts of from 0.5 to 20% by weight, based on the total amount of the etching medium.

According to the present invention the etching paste may be applied to the surface by screen printing, gravure-printing, inkjet printing, dispensing or micro-jetting.

When the etching paste is applied to the surface to be etched it is removed again after a reaction time of 10 s-15 min, preferably after 30 s to 7 min. In a most preferred embodiment of the inventive method the etching paste is removed after a reaction time of 1 minute.

Usually the etching is carried out at elevated temperatures in the range from 20-170° C., preferably in the range from 50 to 130° C. and very particularly preferably from 80 to 120° C. In a preferred embodiment the substrate is heated for 5 minutes to a temperature of 120° C. When the etching is completed, the treated substrate is rinsed with DI water or with a suitable solvent, and the rinsed part is dried with dry air or nitrogen flow.

The new method disclosed herein is especially suitable for the etching of composite materials showing polymer layers comprising Ag-NW (silver nano wires) on plastic substructures, especially on polyurethane, PEN or PET and/or glass sheets. The silver nano wires may be replaced by silver nano particles (nano silver ink) or silver nano wires may be combined with silver nano particles.

Said AgNWs, which are embedded in the polymer layers, build conductive layers with different thickness, density, sheet resistance and transmittance. The embedded AgNWs have a length variation of 1.5 to 15 μm and the diameter varies in the range of 40-150 nm.

Preferably the AgNWs and Ag-nano particles are embedded in conductive polymers selected from the group poly(3-octylthiophene) (P3OT), poly(3-hexyl-thiophene) polymer (P3HT), poly(3,4-ethylene dioxythiophene), or other polythiophene derivatives and polyanilines, or is a combination of polymers like poly[2-methoxy-5-(3′,7′-dimethyloctyloxy)1,4-phenylene vinylene] (MDMO-PPV)/1-(3-methoxycarbonyl)-propyl-1-phenyl)[6,6]C₆₁ (PCBM); poly(3-hexyl-thiophene) polymer (P3HT)/(PCBM) and poly(3,4-ethylene dioxythiophene)/poly(styrene sulfonate) (PEDOT/PSS).

As such the new method enables to etch said layers with a resolution of the printed lines, points or structures of less than 80 μm, usually the resolution is substantially higher.

In the first step the etching paste is printed on the substrate and the etching starts immediately after heat activation. For this the substrate is heated at once to a temperature of about 20° C. to 170° C., preferably to about 80 to 120° C. The temperature is kept for about 10 s to 15 minutes, preferably for 30 s to 7 minutes. In a most preferred embodiment the elevated temperature is kept for 5 minutes at 120° C. Then the etching step is stopped by cleaning with a suitable solvent. Preferably the surface is rinsed with DI water. But in detail the term of heating, the kept temperature and the cleaning has to be adapted to the special nature of the glass sheet or polymer matrix comprising AgNWs and to that of the substructure underneath.

As such, the glass sheet or polymer matrix, the comprising AgNWs and possibly the CNTs are etched by use of a suitable etching paste. In general suitable etching pastes comprise one or more acidic etchant(s), one or more solvent(s), at least a thickener and/or organic filler and possibly further additives improving the printing behaviour, the etching process and the storage stability. The comprising etchant is added in general in form of an aqueous solution. Suitable etchants are those chemicals that react in aqueous solution strongly acidic and can be selected from the group NH₄HF₂, NH₄F, HBF₄, H₂SO₄, HNO₃, Fe(NO₃)₃, FeCl₃, H₃PO₄, Triethylmmonium-chloride, Diammoniumhydrogenphosphate, KBrO₃, KClO₃, KClO₄, CuCl₂, KMnO₄, K₂CrO₄, HCl, NH₄OH, H₂O₂, KNO₃, K₃PO₄, FeSO₄. Suitable thickeners are those which are known for the production of etching pastes. The added thickeners can be particulate or gel forming compounds. The thickeners and organic fillers may be the same or different and may be inorganic or organic polymer particles, or mixtures thereof. In addition to these main ingredients the etching composition may comprise further additives, such as antifoams, thixotropic agents, flow-control agents, deaerators or adhesion promoters for an improved manageability and processability.

In general, the etching paste compositions according to the invention comprise at least one solvent selected from the group water, mono- or polyhydric alcohols, such as glycerol, 1,2-propanediol, 1,2-Ethandiol , 2-Propanol, 1,4-butanediol, 1,3-butanediol, 1,5-pentanediol, 2-ethyl-1-hexenol, ethylene glycol, diethylene glycol and dipropylene glycol, and ethers thereof, such as ethylene glycol monobutyl ether, triethylene glycol monomethyl ether, diethylene glycol monobutyl ether, diethylene glycol monoethyl ether and dipropylene glycol monomethyl ether, and esters, such as [2,2-butoxy(ethoxy)]ethyl acetate, isopropyl acetate, isopropyl formate, esters of carbonic acid, such as propylene carbonate, ketones, such as acetone, 2-butanon, γ-butyrolactone, acetophenone, methyl-2-hexanone, 2-octanone, 4-hydroxy-4-methyl-2-pentanone, pyrrolidone and 1-methyl-2-pyrrolidone, caprolactam, 1,3.Dioxolan, 2-Methyl-1,3-Dioxolan, aldehyds, such as Acetaldehyd, as such or in a mixture. In a most preferred embodiment the etching paste comprises ethylene glycol as solvent. The solvent may be contained in an amount of from 10 to 90% by weight, preferably in an amount of from 15 to 85% by weight, based on the total amount of the medium.

If the etching compositions according to the invention comprise thickeners, these may be selected from the group

cellulose/cellulose derivatives and/or

starch/starch derivatives and/or

xanthan and/or

polyvinylpyrrolidone

polymers based on acrylates of functionalised vinyl units. In general thickeners like this are commercially available.

The prepared etching compositions show at a temperature of 20° C. viscosities in the range of 6 to 45 Pa·s at a shear rate of 25 s-¹, preferably in the range from 10 to 25 Pa·s at a shear rate of 25 s-¹ and very particularly preferably from 15 to 20 Pa·s at a shear rate of 25 s-¹.

Additives having advantageous properties for the desired purpose are for example antifoams, like TEGO® Foamex N which is commercially available,

thixotropic agents, such as BYK® 410, Borchigel® Thixo2,

flow-control agents, such as TEGO® Glide ZG 400,

deaeration agents, such as TEGO® Airex 985, and

adhesion promoters, such as Bayowet® FT 929.

These additives have a positive effect on the printability of the printing paste. The proportion of the additives is in the range from 0 to 5% by weight, based on the total weight of the etching paste.

The method and the paste composition according to the present invention are particularly useful for dispensing or printing of the etching composition which is applied for selectively etching of small structures on plastic substrates. Unexpected for a skilled worker the described method is suitable for the etching of polymer layers comprising AgNWs and possibly silver nano particles and for the etching of the supporting plastic substructure if desired.

The edge sharpness of the etched patterns and the depth of etching in the polymer-based substrates and their layers of variable thickness can be adjusted by variation of the following parameters:
concentration and composition of the etching components
concentration and composition of the solvents
concentration and composition of the thickener systems
concentration and composition of the filler content
concentration and composition of any additives added, such as antifoams, thixotropic agents, flow-control agents, deaeration agents and adhesion promoters
viscosity of the printable etching paste as described in accordance with the invention
etching time with or without input of energy into the etching paste and/or to the substrate to be etched
etching temperature

The etching time can last for a few seconds or for several minutes. This depends on the application, desired etching depth and/or edge sharpness of the etch structures. In general, the etching time is in the range of between a few seconds and 10 minutes, but if necessary the time may be extended.

According to a preferred embodiment of the present invention the printable etching composition is an acidic etching paste, which is prepared by simply mixing the ingredients, as there are the etchant, solvent, thickener and filler or thickener.

The surface to be etched can be a surface or part-surface of a transparent, conductive polymer layer comprising AgNWs and possibly silver nano particles positioned on a support material consisting of flexible plastic or glass sheet. The transparent, conductive polymer may be a polymer selected from the group poly(3-octylthiophene) (P3OT), poly(3-hexyl-thiophene) polymer (P3HT), poly(3,4-ethylene dioxythiophene), or other polythiophene derivatives and polyanilines. The transparent, conductive polymer layer may also comprise a combination of polymers like poly[2-methoxy-5-(3′,7′-dimethyloctyloxy)1,4-phenylene vinylene] (MDMO-PPV)/1-(3-methoxycarbonyl)-propyl-1-phenyl)[6,6]C₆₁ (PCBM); poly(3-hexyl-thiophene) polymer (P3HT)/(PCBM); poly(3,4-ethylene dioxythiophene)/poly(styrene sulfonate) (PEDOT/PSS), wherein the nano tubes, nano wires or nano particles like AgNWs and CNTs are embedded.

A suitable process having a high degree of automation and having high throughput utilises printing technologies to transfer the etching paste to the substrate surface to be etched. In particular, the screen, pad, stamp, ink-jet printing processes are printing processes that are known to the person skilled in the art. Manual application is likewise possible.

Depending on the screen, plate or stamp design or cartridge addressing, it is possible to apply the etching pastes having non-Newtonian flow behaviour which are described in accordance with the invention over the entire area or selectively in accordance with the etch structure pattern only in the areas where etching is desired. All masking and lithography steps which are otherwise necessary are thus superfluous. The etching operation can be carried out with or without energy input, for example in the form of heat radiation (using IR lamps).

The actual etching process is subsequently completed by washing the surfaces with water and/or a suitable solvent. More precisely, the printable, thickener- or polymer particle-containing etching pastes having non-Newtonian flow behaviour are rinsed off the etched areas using a suitable solvent when the etching is complete.

The use of the etching pastes according to the present invention thus enables long runs to be etched inexpensively on an industrial scale in a suitable, automated process.

In a preferred embodiment, the etching paste according to the invention has a viscosity in the range of 10 to 500 Pa·s, preferably of 50 to 200 Pa·s. The viscosity is the material-dependent component of the frictional resistance which counters movement when adjacent liquid layers are displaced. According to Newton, the shear resistance in a liquid layer between two sliding surfaces arranged parallel and moved relative to one another is proportional to the velocity or shear gradient G. The proportionality factor is a material constant which is known as the dynamic viscosity and has the dimension m Pa·s. In Newtonian liquids, the proportionality factor is pressure- and temperature-dependent. The degree of dependence here is determined by the material composition. Liquids or substances having an inhomogeneous composition have non-Newtonian properties. The viscosity of these substances is additionally dependent on the shear gradient.

For the etching of fine structures, having line widths of <90 μm, by printed etching media, it has been found to be particularly advantageous to thicken etching media completely or partially using finely divided particulate systems. Particularly suitable for this purpose are polymer and inorganic particle mixtures which interact with the other components of the composition and form a network by means of chemical bonds or a purely physical interaction at the molecular level. The relative particle diameters of these systems can be in the range from 10 nm to 30 μm.

Corresponding polymer particles having a relative particle diameter in the range from 1 to 10 μm have proved particularly advantageous. Particles which are particularly suitable for the purpose according to the invention can consist of the following materials:
polystyrene
polyacrylic
polyamide
polyethylene
ethylene-vinyl acetate copolymer
ethylene-acrylic acid-acrylate terpolymer
ethylene-acrylate-maleic anhydride terpolymer
polypropylene
polyimide
polymethacrylate
melamine, urethane, benzoguanine, phenolic resin
silicone resin
fluorinated polymers (PTFE, PVDF), and
micronised waxes

The use of a very finely divided polyethylene powder, which is, for example, currently marketed by DuPont PolymerPowders Switzerland under the trade name COATHYLENE HX® 1681, having relative particle diameters d₅₀ value of 10 μm, has proven particularly suitable in the experiments.

These particulate thickeners can be added to the etching medium in amounts in the range of 0.5 to 50% by weight, advantageously in the range of 5 to 40% by weight, in particular of 5 to 20% by weight.

Particularly appropriate are particulate polymeric thickeners based on
polystyrene
polyacrylic
polyamide
polyimide
polymethacrylate
melamine, urethane, benzoguanine, phenolic resin and
silicone resin.

Part of the present invention is therefore a method wherein in step one [step a)] an etching paste is used comprising inorganic particles in an amount in the range of 0.5 to 5% by weight, based on the total amount of the etching medium.

Preferably the comprising polymer particles show mean diameters in the range of 500 nm to 50 μm, most preferably in the range of 0.5 μm to 20 μm.

As said earlier the etching composition may comprise inorganic particles in addition to polymer particles. These inorganic particles may be comprised in the same or less amount of the polymer particles. Suitable inorganic particles are calcium fluoride, boron oxide and sodium chloride, carbon black, graphite and fumed silica. Preferably these inorganic particles show the mean diameters in the range of 10 nm to 500 nm, most preferably in the range of 50 to 150 nm.

Experiments have shown that etching pastes according to the present invention are excellently suitable to be employed in a simplified etching method for polymer-surfaces as characterised in the following description.

The addition of particulate thickeners results in improved resilience of the etching medium. The particles form a skeleton-structure in the etching medium. Similar structures are known to the person skilled in the art from highly dispersed silicic acid (for example Aerosil®). In particular in screen printing of the etching pastes, a broadening of the printed structures due to flow can be substantially prevented or at least greatly restricted by the present invention. Therefore, after printing the areas covered with paste correspond substantially with those determined by the screen layout.

Thickening caused by addition of polymer particles results in a low binding capacity of the etching paste. In this context, a surprisingly high etching rate associated with a significantly increased etch depth for the addition of a particular etchant is found when specific polymer particles in a specific amount had been added to the composition.

This means, that significant advantages arise by use of etching compositions as described here, in particular, through an outstanding screen-printing behaviour which enables to continuous printing of surfaces without interruptions.

The use of etching pastes according to the invention enables surprisingly fine etching structures, because the pastes have high viscosities by addition of a thickener in the presence of polymer particles. This enables the pastes to be applied by printing with a high paste layer. This leads to a deep etching of treated layers because of the achieved height of the printed etching composition, which causes a delayed drying of the printed etching species and a longer etching process.

This is particularly important in the case of etching under elevated temperatures. In addition, the material remaining after the etching process can be removed easily in a final cleaning step. The good rinsing behaviour after etching leads to a short subsequent cleaning.

Surprisingly, experiments have also shown that the addition of corresponding fine polymer particles also have an advantageous effect in processes for selective etching of surfaces made of transparent conductive polymer layers comprising AgNWs, which are used in the production of flexible photovoltaic devices. The same applies for conductive polymer layers comprising silver nano particles. Immediately after application on to the surfaces to be etched, the treated composite material is heated over the entire surface area to temperatures in the range of 20 to 170° C. for a period of time lasting for several seconds to 15 minutes, in particular to temperatures in the range of 50 to 130° C., for 30 s to 7 minutes. Especially preferred are low temperature treatments in the range of 80 to 120° C. The selected temperature is of course set in such a way that changes in the particles present in the paste do not give rise to any disadvantages.

It has been found that an acidic etchant selected from the group NH₄HF₂, NH₄F, HBF₄, H₂SO₄, HNO₃, Fe(NO₃)₃, FeCl₃, H₃PO₄, Triethylmmonium-chloride, Diammoniumhydrogenphosphate, KBrO₃, KClO₃, KClO₄, CuCl₂, KMnO₄, K₂CrO₄, HCl, NH₄OH, H₂O₂, KNO₃, K₃PO₄ and FeSO₄ in aqueous solution is capable to remove completely AgNW comprising conductive, transparent polymer or glass layers having a layer thickness of several hundred nm within a few seconds to minutes at temperatures in the range between 20° C. to 170° C. At 120° C., the etching time is about 1 to 5 minutes. Unexpectedly the conditions for the removal of silver nano particles comprising conductive polymer layers are comparable.

For the preparation of the particle-containing etching compositions according to the invention, the solvents, etching components, thickeners, particles and additives are mixed successively with each other and stirred for a sufficient time until a viscous paste has formed. The stirring can be carried out with warming to a suitable temperature. Usually the components are stirred with each other at room temperature.

Preferred uses of the printable etching pastes according to the invention arise for the described processes for the structuring of AgNW comprising conductive, transparent polymer layers applied to a flexible support material, especially for the production of flexible photovoltaic devices, preferably solar cells.

For application of the pastes to the areas to be treated, the etching pastes can be printed through a fine-mesh screen which contains the print template (or etched metal screen). On use of the etching pastes according to the invention, the applied etching pastes are washed off with a suitable solvent or solvent mixture, preferably with water, after a certain reaction time. The etching reaction is terminated by the washing-off.

Particularly suitable printing methods are essentially screen printing with screen separation or stencil printing without separation. In screen printing, the separation of a screen is usually several hundred μm with a tilt angle a between the edge of the squeegee, which pushes the etching printing paste over the screen, and the screen. The screen is held by a screen frame, while the squeegee is passed over the screen at a squeegee velocity v and a squeegee pressure P. In the process, the etching paste is pushed over the screen. During this operation, the screen comes into contact with the substrate in the form of a line over the squeegee width. The contact between screen and substrate transfers the vast majority of the screen printing paste located in the free screen meshes onto the substrate. In the areas covered by the screen meshes, no screen printing paste is transferred onto the substrate. This enables screen printing paste to be transferred in a targeted manner to certain areas of the substrate.

After the end of the movement E, the squeegee is raised off the screen. The screen is tensioned uniformly using a screen stretcher with hydraulic/-pneumatic tension and clamping device. The screen tension is monitored by defined sag of the screen in a certain area at a certain weight using a dial gauge. With specific pneumatic/hydraulic printing machines, the squeegee pressure (P), the printing velocity (V), the off-contact distance (A) and the squeegee path (horizontal and vertical, squeegee angle) can be set with various degrees of automation of the working steps for trial and production runs.

Printing screens used here usually consist of plastic or steel-wire cloth. It is possible for the person skilled in the art to select cloths having different wire diameters and mesh widths, depending on the desired layer thickness and line width. These cloths are structured directly or indirectly using photosensitive materials (emulsion layer). For the printing of extremely fine lines and in the case of requisite high precision of successive prints, it may be advantageous to use metal stencils, which are likewise provided directly or indirectly with a hole structure or line structure. If necessary, flexible printing devices may be used for the application of the etching composition.

In order to carry out the etching, an etching paste is prepared, as described i.e. in Example 1. Using an etching paste of this type, a AgNW substrate having a thickness of approximately 100 nm can be structured without significant change of contrast-ratio within 5 minutes at 120° C. after screen printing. The etching is subsequently terminated by dipping the devise into water and then rinsing with the aid of a fine water spray.

### LIST OF FIGURES

FIG. 1 shows by way of illustration etch results of alkaline etching composition in comparison to etching compositions according to the invention (NEW). Whereas the alkaline composition removes AgNWs as well as the polymer layer etching compositions according to the invention (NEW) only remove AgNWs without polymer layer damage (extraction on AgNWs)

The new etching compositions lead to a porous resin layer if the etching is processed at a temperature in the range of 80-120° C. and a complete AgNW extraction is achieved (complete decomposition and solution of AgNWs and/or silver nano particles inside the resin layer).

FIG. 2 shows a micrograph of the etching result (etched line pattern) (previous etching method, KOH etchant), where a AGNW comprising polymer layer is etched at 50° C. for 10 min. The paste is screen printed.

FIG. 3: shows a micrograph picture after etching with composition according to the present invention where a AgNW comprising polymer layer is etched at room temperature for 1 min with a composition according to example 1. The paste is screen printed.

FIG. 4 compares the changed optical properties (reflexion spectrum) after the treatment with alkaline etching compositions and with composition of the present invention (NEW). The new etching compositions influence the reflecting behaviour only slight in comparison to nonetched AgNW films whereas the treatment with alkaline etching compositions (KOH) leads to a considerable displacement of reflection over the whole range of measured wave lengths.

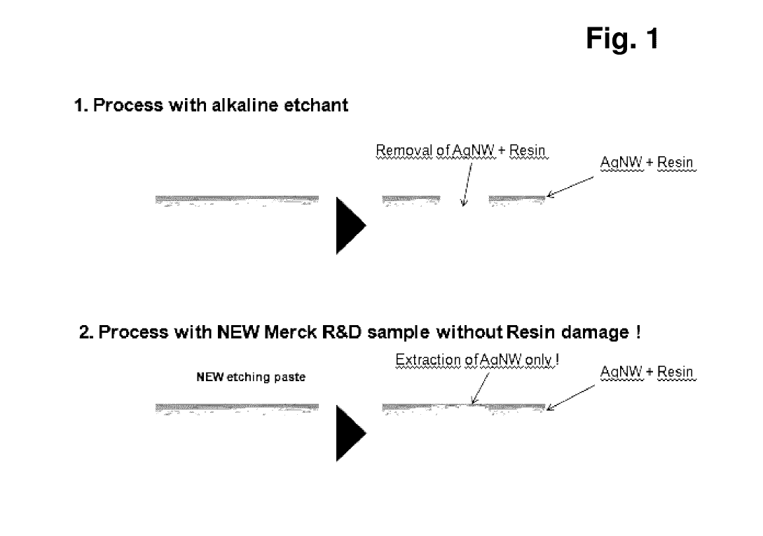

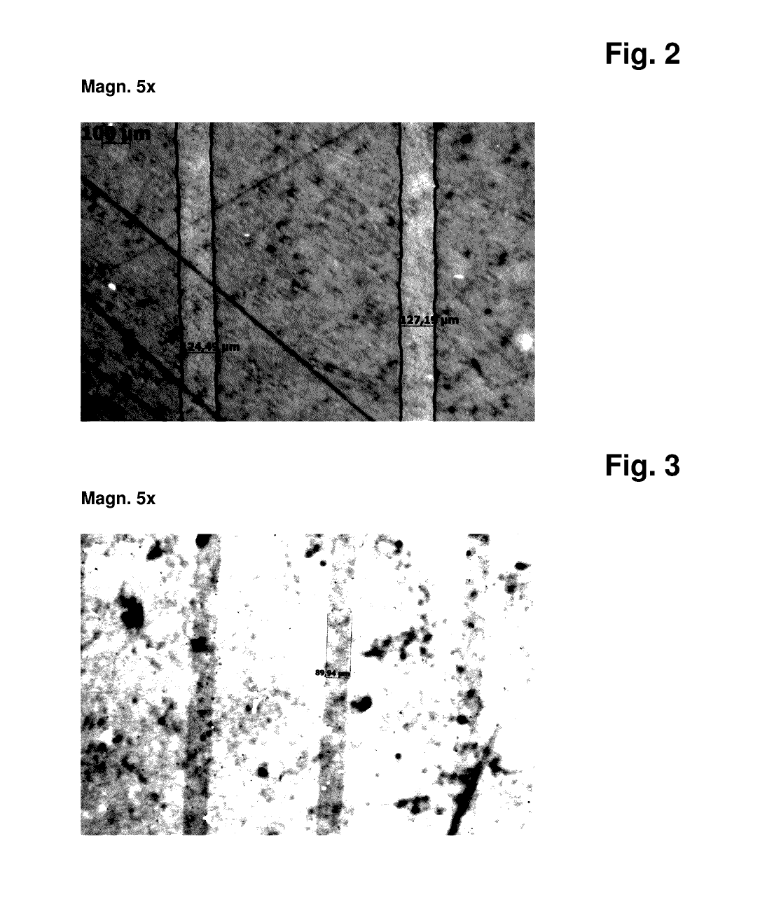

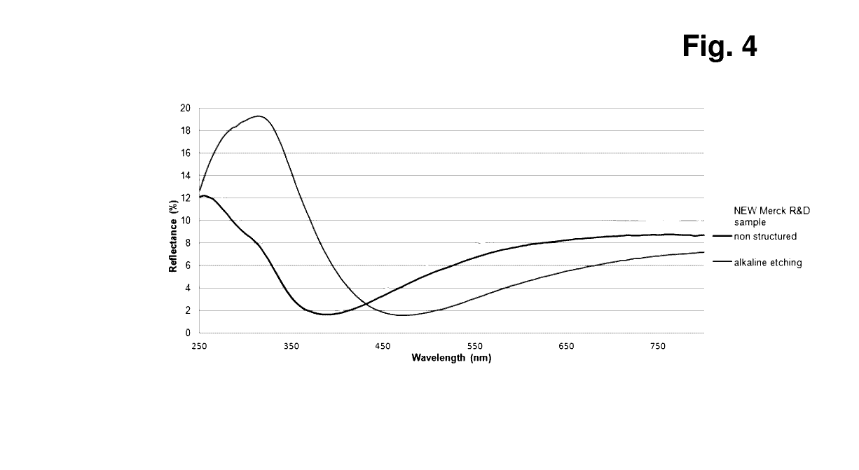

For better understanding and in order to illustrate the invention, examples are given below which are within the scope of protection of the present invention. These examples also serve to illustrate possible variants. Owing to the general validity of the inventive principle described, however, the examples are not suitable for reducing the scope of protection of the present application to these alone.

The temperatures given in the examples are always in ° C. It furthermore goes without saying that the added amounts of the components in the composition always add up to a total of 100% both in the description and in the examples.

The present description enables the person skilled in the art to use the invention comprehensively. If anything is unclear, it goes without saying that the cited publications and patent literature should be used. Correspondingly, these documents are regarded as part of the disclosure content of the present description and the disclosure of cited literature, patent applications and patents is hereby incorporated by reference in its entirety for all purposes.

### EXAMPLES

The acidic etchant, preferably ammoniumhydrogendifluoride, is mixed with the solvent in a beaker with a magnetic stirrer. The thickener is slowly added while stirring the mixture. Then the required filler quantity is added while stirring the mixture.

### Example 1

### Best Mode

135 g Gamma Butyrolactone
38 g H3PO4
20 g HNO3
8 g DI Water
7 g Polyvinylpyrrolidon (PVP) K-120
3 g Vestosint 2070
16 g Aerosil 200

The compounds are successively mixed with each other.

### Example 2

36 g Gamma Butyrolactone
76 g H3PO4
2 g Triethylenammoniumchlorid
14 g DI Water
7 g Polyvinylpyrrolidon (PVP) K-120
3 g Vestosint 2070
11 g Carbon Black

### Example 3

90 g Gamma Butyrolactone
45 g Diethylenglycolmenoethylether
38 g H3PO4
10 g HNO3
8 g DI Water
5 g Polyvinylpyrrolidon (PVP) K-120
3 g Vestosint 2070
16 g Carbon Black

### Example 4

33 g H₃PO₄
2 g Triethylenammoniumchlorid
36 g 1-Methyl-2-pyrrolidone
13 g DI Water
8 g Polyvinylpyrrolidone (PVP) K-120
8 g Aerosil 200
1.5 g Graphite

The etching composition is mixed as described above. The result is a printable etching composition.

The prepared etching composition is screen printed onto the surface of a

AgNW comprising polymer layer, which is supported on a flexible PET substructure or solid glass sheet. After dwell time of 1 min at room temperature, the PET film or glass sheet has to be cleaned by water jet.

Etching results achieved with compositions according to example 1 are shown. Those achieved with compositions of examples 2 to 3 are comparable.

For persons skilled in the art it is obvious that the results can be further improved by adjusting the temperature during the etching and, if necessary, by optimization of the compositions.

1. A method for selective decomposition and release of silver nanowires (AgNWs) and/or of silver nano particles, which are comprising within a polymer matrix, which in turn is positioned on a flexible plastic or glass substructure, comprising the steps:
a) printing an etching paste onto the surface of a composite material comprising the polymer matrix comprising silver nanowires (AgNWs) on a plastic substrate or glass sheet,
b) etching for a predetermined period of time (fixed dwell time) with or without heating and
c) cleaning the substrate surface, with the proviso that the polymer matrix remains and shows a porous structure.
without removal of the polymer matrix

2. A method according to claim 1, characterized in that in step a) an etching paste is printed comprising an etchant selected from the group NH₄HF₂, NH₄F, HBF₄, H₂SO₄, HNO₃, Fe(NO₃)₃, FeCl₃, H₃PO₄, Triethylmmonium chloride, Diammoniumhydrogenphosphate, KBrO₃, KClO₃, KClO₄, CuCl₂, KMnO₄, K₂CrO₄, HCl, NH₄OH, H₂O₂, KNO₃, K₃PO₄, FeSO₄ or a mixture thereof.

3. A method according to claim 1, characterized in that in step a) an etching paste is printed comprising a solvent selected from the group water, mono- or polyhydric alcohols, such as glycerol, 1,2-propanediol, 1,2-Ethandiol, 2-Propanol, 1,4-butanediol, 1,3-butanediol, 1,5-pentanediol, 2-ethyl-1-hexenol, ethylene glycol, diethylene glycol and dipropylene glycol, ether, such as ethylene glycol monobutyl ether, triethylene glycol monomethyl ether, diethylene glycol monobutyl ether, diethylene glycol monoethyl ether, diethylene glycol monoethyl ether and dipropylene glycol monomethyl ether, ester, such as [2,2-butoxy(ethoxy)]ethyl acetate, isopropyl acetate, isopropyl formate, esters of carbonic acid, such as propylene carbonate, ketone, such as acetone, 2-butanon, acetophenone, methyl-2-hexanone, 2-octanone, 4-hydroxy-4-methyl-2-pentanone, pyrrolidone and 1-methyl-2-pyrrolidone, caprolactam, 1,3.Dioxolan, 2-Methyl-1,3-Dioxolan, aldehyde, such as acetaldehyd, as such or mixtures thereof, in an amount in the range of 10 to 90% by weight, preferably in an amount in the range of 15 to 85% by weight based on the total amount of the medium.

4. A method according to claim 1, characterized in that in step a) an etching paste is used comprising organic and/or inorganic particles or mixtures thereof in an amount in the range of 0.5 to 20% by weight, based on the total amount of the etching medium.

5. A method according to claim 1, characterized in that in step a) an etching paste is used comprising inorganic particles in an amount in the range of 0.5 to 5% by weight, based on the total amount of the etching medium.

6. A method according to claim 1, characterized in that in step a) an etching paste is used comprising organic particles or mixtures thereof in an amount in the range of 5 to 20% by weight, based on the total amount of the etching medium.

7. A method according to claim 1, characterized in that in step a) an etching paste is used comprising inorganic particles having mean particle sizes in the range of 50 nm to 150 nm.

8. A method according to claim 1, characterized in that in step a) an etching paste is used comprising organic particles having mean particle sizes in the range of 0.5 μm to 20 μm.

9. A method according to claim 1, characterized in that in step a) an etching paste is used comprising organic polymer particles selected from the group of polystyrene, acrylic polymers, polyamides, polyimides, methacrylic polymers, melamine, urethane, benzoguanine and phenolic resins, silicone resins, micronized cellulose, fluorinated polymers (PTFE, PVDF inter alia) and micronized wax as filler and thickener.

10. A method according to claim 1, characterized in that in step a) an etching paste is used comprising inorganic particles selected from the group calcium fluoride, boron oxide, carbon black, graphite, fumed silica and sodium chloride as filler and thickener.

11. A method according to claim 1, characterized in that in step a) an etching paste is applied onto the surface by screen printing, gravure-printing, inkjetting, dispensing or micro-jetting.

12. A method according to claim 1, characterized in that the heating of the substrate lasts for 10 s-15 min, preferably for 30 s to 7 min, and the temperature being in the range of 20 to 170° C.

13. A method according to claim 1, characterized in that the heating of the substrate lasts for 5 minutes at 100° C.

14. A method according to claim 12, characterized in that the treated substrate is rinsed with DI water or with a solvent; and that the rinsed part is dried with dry air or nitrogen flow.

15. A method according to claim 1, wherein said plastic is polyurethane, PEN (polyethylene naphthalate) or PET (polyethylene terephatalate).

16. A method according to claim 1, wherein the AgNWs (silver nano wires), which are embedded in conductive polymer layers, have a length variation from 1.5 to 15 μm and diameter varies from 40-150 nm.

17. A method according to claim 1, wherein the silver nano particles (Ag nano ink), which are embedded in conductive polymer layers, have a length variation in the range of 1.5 to 15 μm and mean diameter in the range of 40-150 nm.

18. A method according to claim 1, wherein the conductive polymer is selected from the group poly(3-octylthiophene) (P3OT), poly(3-hexyl-thiophene) polymer (P3HT), poly(3,4-ethylene dioxythiophene), or other polythiophene derivatives and polyanilines, or is a combination of polymers like poly[2-methoxy-5-(3′,7′-dimethyloctyloxy)1,4-phenylene vinylene] (MDMO-PPV)/1-(3-methoxycarbonyl)-propyl-1-phenyl)[6,6]C₆₁ (PCBM); poly(3-hexyl-thiophene) polymer (P3HT)/(PCBM) and poly(3,4-ethylene dioxythiophene)/poly(styrene sulfonate) (PEDOT/PSS).

19. A method according to claim 1, wherein the resolution of the printed lines, dots or structures is less than 90 μm.
